(19) United States
(12) Patent Application Publication
(10) Pub. No.: US 2025/0116312 A1
(43) Pub. Date: Apr. 10, 2025

(54) CONTROL ARRANGEMENT FOR A FREQUENCY-DEPENDENT DAMPING VALVE DEVICE OF A VIBRATION DAMPER AND METHOD FOR PRODUCING THE CONTROL ARRANGEMENT

(71) Applicant: ZF Friedrichshafen AG, Friedrichshafen (DE)

(72) Inventors: Andreas VÄTH, Schweinfurt (DE); Jan DEPPERT, Gochsheim (DE); Andreas SIEBER, Schweinfurt (DE); Dirk LITTERSCHEID, Eitorf (DE); Achim EICH, Lohmar (DE); Stefan LIEHMANN, Hofheim (DE)

(21) Appl. No.: 18/904,624

(22) Filed: Oct. 2, 2024

(30) Foreign Application Priority Data
Oct. 9, 2023 (DE) 10 2023 209 800.8

(51) Int. Cl. F16F 9/50; F16F 15/00

(52) U.S. Cl. CPC F16F 9/50; F16F 15/002; F16F 2228/04

(57) ABSTRACT

A control arrangement for a frequency-dependent damping valve of a vibration damper having a control pot with a cylindrical pot wall and a pot base adjoining the pot wall, a control piston arranged axially displaceable in the control pot between first and second end positions. The pot base has a deformation portion produced by plastic deformation that defines the first end position. The control piston is slidingly guided at a guide bush. The deformation portion defines a trough in which the guide bush is received by a first axial end and a spring unit supported at the control piston acts on the control piston with a spring force. The guide bush has a cutout at the first axial end arranged in the trough and in which a base material of the control base is displaced by plastic deformation to form a positive engagement connection.

### BACKGROUND OF THE INVENTION

### 1. Field of the Invention

The disclosure is directed to a control arrangement for a frequency-dependent damping valve device of a vibration damper and to a method for producing the control arrangement.

### 2. Description of Related Art

Particularly in the automotive field, vibration dampers are used in a chassis of a vehicle, usually in combination with a suspension. Such vibration dampers are usually formed by at least one damper tube and a piston rod which is movable relative to the latter, the damper tube and piston rod being hydraulically damped relative to one another via a piston valve. For this purpose, the piston valve is arranged at a lower end of the piston rod and divides the interior space of the damper tube into two work chambers. Frequency-dependent damping valves are used in order to control the damping force of the shock absorber, and the oil flow in the shock absorber can be redirected or blocked when necessary in order to effect an adjustment of the damping force in relation to the motion frequency of the vehicle.

DE 10 2015 220 707 A1 discloses a control arrangement for a frequency-dependent damping valve device of a vibration damper comprising a control pot and a control piston which is axially displaceably arranged in the control pot. The control piston axially limits a control space which is enclosed in the control pot, this control space communicating with the damping valve device via an inlet connection. A spring element is arranged between the control piston and the damping valve, which spring element axially introduces a spring force into the control piston on the one hand and into the damping valve on the other hand. When the control space is filled with damping fluid, the control piston displaces in direction of the damping valve and increases the pressing pressure of the valve disk of the damping valve via the spring element, which increases the damping force. The control arrangement is characterized in that the axial position of the stop in the control arrangement is adjusted by a plastic deformation of the pot base. The pot base has a deformation portion which is produced by the plastic deformation, the deformation portion having a trough which partially receives the guide bush, and the cross section of the trough corresponds to the outer cross section of a portion of the guide bush received in the trough.

### SUMMARY OF THE INVENTION

An object of one aspect of the invention is to provide a control arrangement of the type described above which is characterized by a high functional reliability. A further aspect of the invention is a method for producing the control arrangement.

One aspect of the invention is a control arrangement which is formed and/or suitable for a frequency-dependent damping valve device of a vibration damper. The damping valve device preferably has a damping piston which is movement-coupled with a piston rod and which comprises a rebound step damping valve operative in the rebound direction of the piston rod for generating a damping force when the vibration damper moves out, i.e., the rebound step, and/or a compression step damping valve operative in the compression direction of the piston rod for generating a damping force when the vibration damper moves in, i.e., the compression step. The control arrangement serves in particular for generating damping force in a speed-dependent and/or frequency-dependent manner. The control arrangement is in operative connection with one of the damping valves, particularly the rebound step damping valve. The damping valve is outfitted with at least one valve disk which is influenced in a frequency-dependent manner by the control arrangement. The frequency-dependent damping valve device is accordingly formed of the damping valve and the control arrangement which acts on the damping valve in a frequency-dependent manner.

The control arrangement has a control pot that has a cylindrical pot wall and an annular pot base adjoining the pot wall. Simply put, the control pot is formed as a cylindrical pot, the pot base having a central through-opening through which the piston rod is guided. The pot wall and the pot base are preferably formed from a common material portion, in particular they are formed integrally.

The control arrangement has a control piston arranged in the control pot so as to be displaceable axially with respect to a main axis between a first end position and a second end position and axially limits a control space enclosed in the control pot. The control space is preferably filled with damping medium via at least one, or exactly one, control channel depending upon excitation frequency, as a result of which the control piston is displaced and a pressure on the valve disk of the damping valve is at least indirectly increased or reduced. Accordingly, the control piston acts on the valve disk in the closing direction thereof. The control piston preferably contacts the pot wall sealingly in radial direction, e.g., via at least one sealing ring. In particular, the main axis is defined by a longitudinal axis of the piston rod.

The pot base has a deformation portion produced by plastic deformation and which defines at least one, or exactly one, axial end stop for the control piston in the first end position. In particular, the axial position of the end stop is adjusted and/or adjustable by the plastic deformation of the pot base. Simply put, the end stop defines the maximum axial travel of the control piston inside of the control pot in direction of the pot base. The end stop is preferably constructed as an axial ridge of the pot base at least in some portion thereof. The soft and/or hard damping force characteristic can be realized by the limitation of the axial travel of the control piston inside of the control pot. In particular, the soft damping force characteristic is generated when the control piston is disposed in the first end position. Optionally, the control arrangement can have a further end stop for the control piston in the second end position which defines the maximum axial travel of the control piston inside of the control pot in direction of the valve disk of the damping valve. The damping force characteristic generated in this state is defined as hard damping force characteristic.

The control arrangement has a guide bush that is guided coaxially with respect to the main axis through the control piston, the control piston being slidingly guided at a lateral surface of the guide bush. In other words, the control piston surrounds the guide bush in circumferential direction.

The further end stop is preferably arranged and/or formed at the guide bush. To this end, the guide bush can have a radial shoulder that defines the further end stop. Alternatively or optionally additionally, the further end stop can be formed by an axially fixed stop ring surrounding the guide bush. In particular, the guide bush and the control pot are arranged coaxial to one another with respect to the main axis. Simply put, the control piston is formed as a annular piston which has a central through-opening through which the piston rod can be guided.

The deformation portion defines a trough in which the guide bush is partially received by a first axial end. In particular, the guide bush is coaxially centered in the trough with respect to the main axis. The guide bush can be received in a positively engaging manner in the trough axially in direction of the pot base and radially in direction of the pot wall with respect to the main axis. In other words, the cross section of the trough corresponds to the outer cross section of the axial end of the guide bush that is received in the trough. When installation is effected as intended, the piston rod is guided through the guide bush, the guide bush being axially fixed at the damping valve, particularly the valve disk thereof, on one hand and at a fastener, e.g., a screw nut, on the other hand. Specifically, the at least one control channel is formed at least partially between the guide bush and the control piston.

Further, the control arrangement has a spring unit supported at the control piston axially with respect to the main axis and acts on the control piston with a defined spring force directed in direction of the pot base. When installation is effected as intended, the spring unit is arranged between the control piston and the valve disk of the damping valve, the control arrangement being constructed in such a way that the control piston displaces in the control space relative to the valve disk of the damping valve depending on the damping fluid pressure, respectively tensions or relaxes the spring unit, and accordingly influences the application of spring force on the valve disk by the spring unit and therefore influences the damping force of the damping valve. In particular, the spring unit can comprise at least one, or exactly one, spring element which can be constructed as a helical spring or a spring disk, for example. The spring unit usually comprises at least two spring elements, and at least one, or exactly one, annular spacer element can be arranged between the spring elements. The axial extension of the spacer element preferably influences the preloading of the spring unit.

It is proposed within the framework of the invention that the guide bush has at a first axial end in the area of the trough at least one, or exactly one, cutout in which a base material of the control pot is displaced by plastic deformation to form a positive engagement connection. In particular, the positive engagement connection serves to captively secure the control pot to the guide bush in axial direction with respect to the main axis. The cutout is preferably arranged axially inside of the trough so that the base material partially flows into the cutout during the plastic deformation. Simply put, a portion of the deformed material of the pot base is accordingly displaced into the cutout so that a transmission of force is carried out by the positive engagement.

One aspect of the invention is based on the insight that a shearing process (plastic deformation) of the control pot takes place as a result of a sharp-edged tool during the production process of the control arrangement. This shearing process primarily has the aim of defining the “start position” (end stop) working point of the control piston. Beyond this, the control pot is fixed to the guide bush via this shearing process. If the control pot detaches from the guide bush, the function of the control arrangement can no longer be ensured so that such a control arrangement is to be discarded.

The advantage of aspects of the invention consists in that, because a cutout is formed at the guide bush, a permanent fastening of the control pot to the guide bush can be produced in a simple manner by plastic deformation. Since a plastic deformation of the pot base takes place anyway over the course of the production process, the cutout further allows the control pot to be fixed in a particularly cost-effective manner. The function of the control arrangement can be ensured throughout the entire manufacturing and assembly process of the vibration damper by the positive engagement connection, which enhances the functionality of the vibration damper.

In a concrete configuration, it is provided that the control pot, the control piston, the guide bush and the spring unit are held together in a preassembly state via the positive engagement connection to form a common constructional unit. Over the course of a production process, the spring unit of the control piston and the control pot are slid onto the guide bush one after the other coaxially, and the pot base is subsequently plastically deformed by a deformation tool to secure the end stop and form the positive engagement. In particular, the control piston and the spring unit are captively held at the guide bush axially with respect to the main axis by the control pot. The positive engagement connection particularly preferably serves as transport safety for the preassembled control arrangement. In other words, the control pot, the control piston, the guide bush and the spring unit form a self-retaining subassembly. Accordingly, the control arrangement can be provided as a preassembled constructional unit, and the handling of the control arrangement is appreciably improved during the manufacturing and assembly process.

In a further configuration, it is provided that the control pot is held at the guide bush via the positive engagement connection free from play in radial direction and axial direction with respect to the main axis. In particular, the cutout is configured in such a way that a positive engagement is formed between the control pot and the guide housing in axial direction and also in opposite axial direction with respect to the main axis. The base material preferably flows radially inwardly into the cutout during the plastic deformation. In addition, the deformation portion, preferably the trough, is formed at the outer contour of the guide bush in such a way that it contacts the axial end of the guide bush received in the trough in a positively engaging and/or frictionally engaging manner in radial direction. Due to the fact that the guide bush is fixed free from play in radial direction and axial direction, the axial end stop or the first end position of the control piston can be fixed in a particularly precise manner. In addition, it can be ensured that the end stop is retained over the duration of the entire assembly process.

In a concrete implementation, it is provided that the at least one cutout is formed by an undercut arranged inside of the trough. In particular, the control pot is fixed axially in both directions relative to the guide bush by the undercut. In other words, the cutout is limited in direction of the pot base by a material projection with undercut. For example, the undercut can be wedge-shaped or substantially wedge-shaped considered in a longitudinal section with respect to the main axis. It is particularly preferably provided that the plastically deformed base material fills the undercut in large part or entirely. Therefore, as a result of the undercut, a particularly secure positive engagement connection is ensured in both axial directions with respect to the main axis.

It is provided in a further development that the undercut has an axial surface extending in a radial plane of the main axis and a diagonal surface arranged at an acute angle to the axial surface. In particular, the diagonal surface is arranged at an angle of less than 90° to the axial surface. The angle is preferably less than 80°, preferably less than 70°, specifically less than 60°. Alternatively or optionally additionally, the diagonal surface is inclined at an angle of between 20° and 40° relative to the main axis. The positive engagement connection with the plastically deformed base material is formed in the one axial direction by the axial surface and in the other axial direction by the diagonal surface. Accordingly, a particularly secure positive engagement connection can be ensured between the control pot and the guide bush. In addition, the material flow during the plastic deformation can be improved.

In a concrete implementation, it is provided that the axial surface limits the cutout axially, particularly in direction of the spring arrangement, and the undercut is formed by the diagonal surface. Simply put, the diagonal surface forms the undercut surface. The material flow is particularly preferably guided along the diagonal surface into the cutout during the plastic deformation and fills the cutout formed there. A secure and permanent connection of the two structural component parts is ensured in this way.

Concretely, it is provided that the undercut is inserted in an axial end face of the guide bush, and a shearing edge is formed between the diagonal surface and the end face. In particular, the cutout formed in this way is open radially outwardly and axially in direction of the pot base. The diagonal surface preferably connects the axial surface to the end face, the shearing edge being formed by the transition between the diagonal surface and the end face. In particular, the base material can flow or slide off into the cutout via the shearing edge and along the diagonal surface during the plastic deformation. Accordingly, an undercut is suggested which is arranged in immediate proximity to the pot base so that a positive engagement connection between the pot base and the guide bush is ensured already with just a slight plastic deformation of the pot base.

In an alternative construction, it is provided that the diagonal surface limits the cutout axially, particularly in direction of the spring arrangement, and the undercut is formed by the axial surface. Simply put, the axial surface forms the undercut surface. Accordingly, during the plastic deformation, the material flow is particularly preferably guided along the axial surface into the cutout and fills the undercut formed there. A secure and permanent connection of the two structural component parts is likewise ensured in this way.

In one aspect of the invention, it is provided that the undercut is inserted into the lateral surface of the guide bush, a shearing edge being formed between the axial surface and the lateral surface. In particular, the cutout formed in this way is open radially outwardly and is slightly spaced apart axially from the pot base. For example, the spacing amounts to less than 0.2 mm, preferably less than 0.1 mm. The axial surface preferably connects the diagonal surface to the lateral surface, the shearing edge being formed by the transition between the axial surface and the lateral surface. In particular, the base material can flow or slide off into the cutout via the shearing edge and along the axial surface during the plastic deformation. Accordingly, an undercut is suggested that is arranged in the vicinity of the pot base such that a positive engagement connection between the pot base and the guide bush is likewise already ensured with just a slight plastic deformation of the pot base.

In a further development, it is provided that the axial surface and the diagonal surface are connected to one another inside of the cutout, particularly viewed in longitudinal section along the main axis, via a radius. For example, the radius of the cutout introduced into the end face amounts to less than 0.01 mm, preferably less than 0.05 mm. For example, the radius of the cutout inserted in the lateral surface amounts to less than 0.5 mm, preferably less than 0.2 mm. The material flow during the plastic deformation can be improved by the radius and, accordingly, it can be ensured that the cutout or undercut is completely filled.

In a concrete implementation, it is provided that the at least one cutout is formed continuously in circumferential direction. The cutout is preferably formed as a groove, preferably an annular groove, surrounding the main axis. Accordingly, a cutout is suggested that ensures a particularly reliable positive engagement connection between the control pot and the guide bush. In addition, as a result of the circumferential cutout, the spring force applied to the control piston by the spring arrangement can be supported particularly securely in the guide bush in the preassembly state, since the spring force is supported over the entire circumference.

In a further aspect, it is provided that the at least one cutout is produced by cutting. The guide bush is preferably formed as a turned part, and the cutout, particularly the circumferentially continuous cutout, is produced by turning. Accordingly, a cutout is suggested which can be realized in a particularly simple manner in technical respects relating to manufacture and, therefore, economically in the manufacturing process for the guide bush.

In a further aspect, it is provided that the guide bush has at a second axial end a radially outwardly directed positive engagement contour via which the spring unit is supported axially with respect to the main axis. In particular, the positive engagement contour serves to captively hold the spring unit and the control piston in the preassembly state axially between the control pot and the positive engagement contour. In particular, the positive engagement contour is formed by a neck, collar, flange, or the like extending around the main axis. In principle, the at least one spring element can be directly supported at the positive engagement contour. Alternatively, the spring unit has a supporting element, preferably a supporting disk, via which the spring element is supported at the positive engagement contour. Accordingly, a securing of all of the structural component parts of the control arrangement in the preassembly state at the guide bush is ensured in a simple and cost-effective manner.

A further aspect of the invention relates to a method for producing the control arrangement already described above in which the spring unit, the control piston and the control pot are preassembled at the guide bush, the pot base of the control pot is plastically deformed in an axial direction with respect to the main axis by a deformation tool, and a base material of the control pot is displaced under the application of force into the cutout to form the positive engagement. The deformation tool preferably has a contact portion that comes in contact at the pot base and executes a defined path in direction of the guide bush under the application of force parallel to the main axis. For example, the contact portion is formed circumferential to the main axis and/or has an annular surface surrounding the main axis. The pot base is preferably plastically deformed in the region of the contact portion. The guide bush axially supports the pot base at the side remote of the deformation tool and serves as an abutment for the deformation tool. Particularly preferably, the deformation tool has a recess, and the cross section of the recess substantially corresponds to the outer contour of the first axial end of the guide bush. In particular, the control pot, particularly the pot base, is deformed without cutting and/or is cold-deformed by the deformation tool.

Optionally, the control arrangement can be fixed between a first structural component part of a fixing device and a second structural component part of the fixing device before the deformation process. The control arrangement can be arranged as a constructional unit comprising at least the guide bush and the control pot between the first structural component part and the second structural component part and clamped by introducing a fixing force. The guide bush makes contact at the pot base axially with respect to the main axis.

In one embodiment, it is provided that the spring unit and the control piston are preassembled at the guide bush in an intermediate step, and the guide bush is plastically deformed in an axial direction with respect to the main axis by a further deformation tool, a base material of the guide bush being radially outwardly displaced under the action of force to form a transport securing device. In particular, at least one, preferably three, stem(s) serving to axially secure the control piston at the guide bush are produced at the guide bush by the further deformation tool. Accordingly, the spring unit and the control piston can be handled in a simple manner as a preassembled constructional unit during the assembly process, particularly in a series installation.

### BRIEF DESCRIPTION OF THE DRAWINGS

Further features, advantages and effects of the invention will become apparent from the following description of preferred exemplary embodiments of the invention. The drawings show:

FIG. 1 is a sectional view of a damping valve device;

FIG. 2 is a detail illustration of the damping valve device from FIG. 1;

FIG. 3 is a detail illustration of a guide bush of a control arrangement of the damping valve device from FIG. 1;

FIG. 4 is a construction of a guide bush; and

FIG. 5 is a sectional view of the control arrangement from FIG. 1 during a deformation process.

### DETAILED DESCRIPTION OF THE PRESENTLY PREFERRED EMBODIMENTS

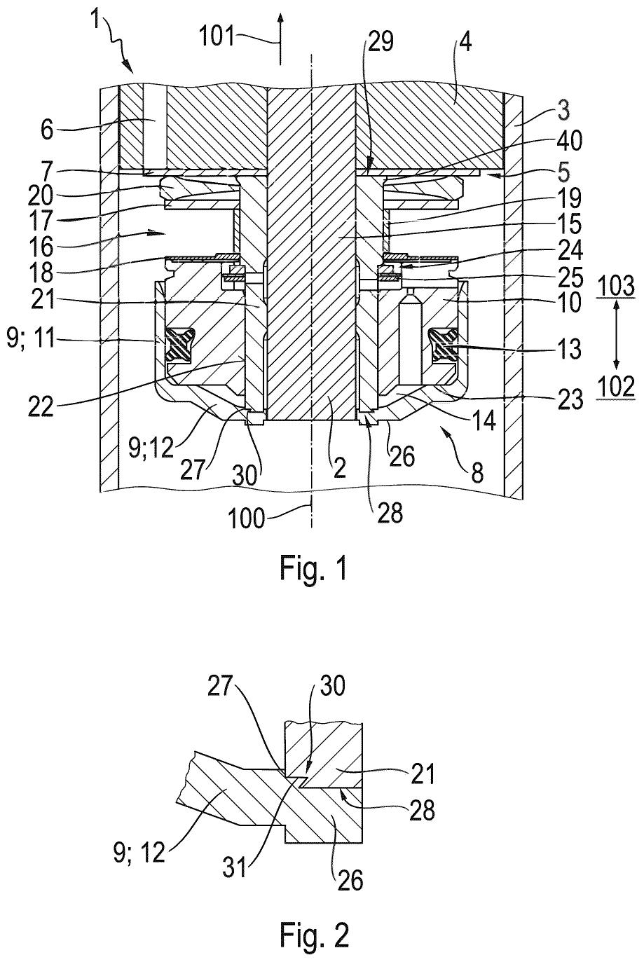

FIG. 1 shows a frequency-dependent damping valve device 1 for a vibration damper of a motor vehicle. The damping valve device 1 is fastened by its end to a piston rod 2, particularly a piston rod tenon, and is arranged so as to be axially displaceable inside of a cylinder 3 of the vibration damper. For example, the damping valve device 1 can be axially secured to the piston rod 2 by a fastening nut, not shown. The longitudinal axis of the piston rod 2 defines a main axis 100.

The damping valve device 1 has a damping piston 4 arranged coaxial to the main axis 100 and which sealingly contacts the inner circumference of the cylinder 3 in radial direction with respect to the main axis 100, for example, via a piston seal, and divides an interior space of the cylinder 2 into a workspace on the piston rod side and a workspace remote of the piston rod. The interior space of the cylinder is usually filled with a damping fluid.

The damping valve device 1 has at least one damping valve 5, preferably a rebound step damping valve, which cooperates with a flow channel 6 formed in the damping piston 4. To this end, the damping valve 5 has at least one valve disk 7 which axially covers the flow channel 6. During an axial movement of the piston rod 2 relative to the cylinder 3, the damping fluid is forced through the flow channel 6. This flow of damping fluid is then damped through the valve disk 7. The damping force at least partially depends on the resilience of the valve disk 7. The damping valve device 1 can additionally have a further damping valve, not shown, preferably a compression step damping valve, which cooperates with the damping piston 4 in an opposite flow direction of the damping fluid.

The damping valve device 1 further comprises a control arrangement 8 mounted at the piston rod 2 coaxial to the main axis 100 on the side of the damping valve 5 remote of the damping piston 4. The control arrangement 8 comprises a control pot 9 which has a cylindrical pot wall 11 and an annular disk-shaped pot base 12 adjoining the pot wall 11. The pot wall 11 and the pot base 12 are produced, for example, by forming processes, from a common material portion. For example, the control pot 9 is formed as a shaped sheet-metal component part.

The control arrangement 8 has a control piston 10, which is axially displaceable in the control pot 9 and sealed relative to the pot wall 11 via a sealing ring 13. The control piston 10 axially limits a control space 14 which is enclosed in the control pot 9 and which fluidically communicates with the workspace of the cylinder 3 on the piston rod side via a further flow channel 15.

The control arrangement 8 has a spring unit 16 arranged axially between the control piston 10 and the damping piston 4. The spring unit 16 is formed to apply spring force on the control piston 10 on the one hand and the at least one valve disk 7 on the other hand. During a rebound movement 101 of the piston rod 2, a portion of the damping fluid flows into the control space 14 via the further flow channel 15, as a result of which the control piston 10 is displaced axially in direction of the damping valve 5 and the spring force of the spring unit 16 is increased. The pressing pressure on the valve disk 7 is accordingly increased, which in turn leads to an increase in the damping force.

The spring unit 16 comprises a plurality of spring elements 17, 18, a sleeve-shaped spacer element 19 being arranged between the spring elements 17, 18. For example, the spring elements 17, 18 are formed, respectively, by at least one spring disk. In addition, the spring unit 16 has a supporting element 20 which is formed as a supporting disk and via which the spring arrangement 16 is axially supported at the valve disk 7. The supporting element 20 is supported axially between the valve disk 7 and the spring elements 17.

The control arrangement 8 additionally has a guide bush 21 at which the control piston 10 and the spring unit 16 are arranged or guided coaxially. The guide bush 21 is guided through the control piston 10 and the spring unit 16, and the latter are slidingly guided at a lateral surface 22 of the guide bush 21 when the control piston 10 is displaced axially with respect to the main axis 100.

The pot base 12 of the control pot 9 has an axial end stop 23 that defines a first axial end position 102 for the control piston 10. The end stop 23 serves as axial stop for the control piston 10, as a result of which the axial movement of the control piston 10 is limited in direction of the pot base 12 and a soft damping force characteristic is influenced. The end stop 23 is constructed as an at least partial ridge of the pot base 12 for this purpose.

In addition, the guide bush 21 has a further axial end stop 24 which defines a second axial end position 103 for the control piston 10. The further end stop 24 serves as a further axial stop for the control piston 10, as a result of which the axial movement of the control piston 10 is limited in direction of the valve disk 7 and a hard damping force characteristic is influenced. The further end stop 24 is formed by a radial shoulder formed at the guide bush 21, at least one stop disk 25 being axially supported at the radial shoulder.

In order to adjust the axial end stop 2, the pot base 12 has a deformation portion 26 which is produced by plastic deformation and by which a trough 27 is formed. The guide bush 21 is at least partially received in the trough 27 by a first axial end 28 remote of the damping piston 4, the guide bush 21 being fixed inside of the trough 27 via a positive engagement connection 30 at the guide bush 21.

As is shown in FIG. 2, the guide bush 21 has a cutout 31 in the region of the trough 27, a base material of the pot base 12 being displaced into the cutout 31 during the plastic deformation in order to form the positive engagement 30. The pot base 12 is irreversibly plastically deformable and has a lower yield strength than the guide bush 21. The base material of the pot base 12 displaced by the plastic deformation is received in its entirety in the cutout 27. In this way, the control pot 9 is captively secured, preferably so as to be free from play, at the first axial end 28 of the guide bush 21 in radial direction with respect to the main axis 100 by the cutout 27 and in axial direction with respect to the main axis 100 by the positive engagement connection 30.

For further axial securing of the control piston 10 and the spring unit 16, the guide bush 21 has a positive engagement contour 40 at a second axial end 29 facing the damping piston 4, the supporting element 20 being supported at the positive engagement contour 40 axially in direction of the damping piston 5. The positive engagement contour 40 is formed by a radial diameter enlargement, particularly a radially outwardly directed collar.

As a result of the positive engagement connection 30 at the first end 28 and the positive engagement contour 40 at the second end 29, the control pot 9, the control piston 10, the spring unit 16 and the guide bush 21 are held together in a preassembly state to form a common constructional unit.

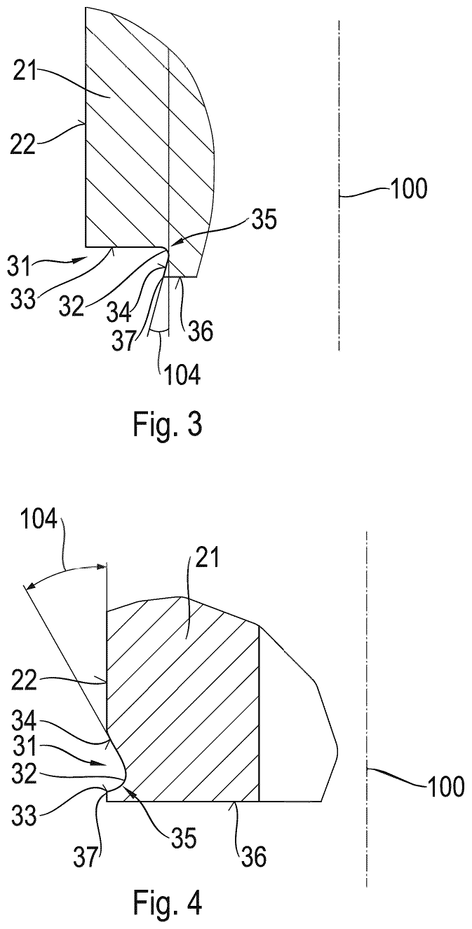

As is shown in FIGS. 3 and 4, the cutout 31 is formed by an undercut 32 arranged inside of the trough 27 and formed at the guide bush 21, for example, circumferentially with respect to the main axis 100. For example, the undercut 32 can be produced at the guide bush 21 by cutting, for example, by turning. The undercut 32 has an axial surface 33 extending in a radial plane of the main axis 100 and a diagonal surface 34 arranged with an acute angle relative to the axial surface 33, the axial surface 33 and diagonal surface 34 being connected to one another in the region of the undercut 32 via a radius 35.

As is shown in FIG. 3, the undercut 32 is inserted in an axial end face 36 of the guide bush 21, the axial surface 33 limiting the cutout 31 axially with respect to the main axis 100 and the undercut 32 being formed by the diagonal surface 34. In other words, the diagonal surface 34 forms an undercut surface. To this end, the diagonal surface 34 can be inclined at an angle 104 of approximately 30° relative to the main axis 100. The diagonal surface 34 connects the axial surface 33 to the end face 36. A shearing edge 37 surrounding the main axis 100 is formed between the diagonal surface 34 and the end face 34. The base material is sheared off via the shearing edge 37 during the plastic deformation and fills the undercut 32. Accordingly, during the deformation process, the base material flows along the diagonal surface 34 into the undercut 32. For example, the cutout 31 has an axial depth of approximately 0.2 mm and a radial depth of approximately 0.55 mm. The radius 35 amounts to 0.05 mm, for example.

As is shown in FIG. 4, the undercut 32 is inserted in the lateral surface 22 of the guide bush 21. The diagonal surface 34 bounds the cutout 31 axially with respect to the main axis 100, and the undercut 32 is formed by the axial surface 33. In other words, the axial surface 33 forms an undercut surface. The axial surface 33 connects the diagonal surface 34 to the lateral surface 22, a shearing edge 37 surrounding the main axis 100 being formed between the axial surface 33 and the lateral surface 22. The base material is sheared off via the shearing edge 37 during the plastic deformation and fills the undercut 32. During the deformation process, the base material accordingly flows along the axial surface 33 into the undercut 32. The diagonal surface 34 can be inclined at an angle 104 of approximately 30° relative to the main axis 100 in this embodiment. For example, the cutout 31 has an axial width of approximately 0.7 mm and a radial depth of approximately 0.2 mm. The radius 35 amounts to 0.2 mm, for example. Additionally, the cutout 31 can be spaced apart from the end face 36 at an axial distance of approximately 0.03 mm.

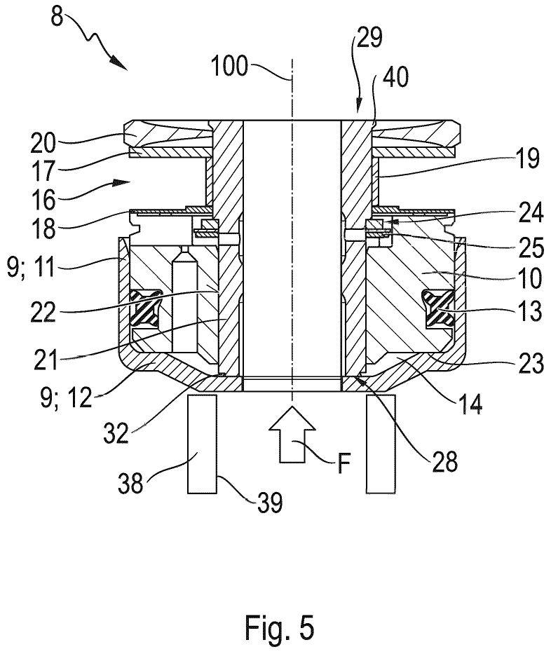

FIG. 5 schematically shows a preassembly of the control arrangement 8. To this end, the spring unit 16, the control piston 10 and the control pot 12 are preassembled coaxial to the main axis 100 at the guide bush 21 and are positionally correctly fixed with respect to one another, for example, by a fixing device, not shown. The guide bush 21 comes in contact with the first axial end 28 axially at the pot base 12.

A deformation tool 38 is subsequently applied at a side of the pot base 12 remote of the guide bush 21, the guide bush 21 serving as an abutment for the deformation tool 38. The deformation tool 38 executes a defined path in axial direction parallel to the main axis 100 and introduces a defined force F in axial direction into the pot base 12 in order to plastically deform the latter. In order to form the deformation portion 26, as is described in FIG. 1, the deformation tool 38 has a recess 39, the inner diameter of which substantially corresponds to an outer diameter of the guide bush 21 at the first axial end 28.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A Control arrangement for a frequency-dependent damping valve device of a vibration damper; comprising:
a control pot which has a cylindrical pot wall and an annular pot base adjoining the cylindrical pot wall;
a control piston arranged in the control pot so as to be axially displaceable with respect to a main axis of the vibration damper between a first end position and a second end position and, together with the control pot, limits a control space;
a deformation portion of the annular pot base produced by plastic deformation and which defines an axial end stop for the control piston in the first end position;
a guide bush guided coaxially with respect to the main axis through the control piston, wherein the control piston is slidingly guided at an outer lateral surface of the guide bush, and wherein the deformation portion defines a trough in which the guide bush is partially received by a first axial end;
a spring unit supported at the control piston axially with respect to the main axis and which acts on the control piston with a spring force; and
at least one cutout at the first axial end of the guide bush arranged in the trough and in which a base material of the annular pot base is displaced by plastic deformation to form a positive engagement connection.

2. The control arrangement according to claim 1, wherein the control pot, the control piston, the spring unit and the guide bush are held together in a preassembly state via the positive engagement connection to form a common constructional unit.

3. The control arrangement according to claim 1, wherein the control pot is secured at the guide bush free from play via the positive engagement connection at least in an axial direction with respect to the main axis.

4. The control arrangement according to claim 1, wherein the at least one cutout is formed by an undercut arranged inside of the trough.

5. The control arrangement according to claim 4, wherein the undercut has an axial surface extending in a radial plane of the main axis and a diagonal surface arranged with an acute angle relative to the axial surface.

6. The control arrangement according to claim 5, wherein the axial surface limits the at least one cutout axially with respect to the main axis, wherein the undercut is formed by the diagonal surface.

7. The control arrangement according to claim 6,
wherein the undercut is inserted in an axial end face of the guide bush, and
wherein a shearing edge is formed between the diagonal surface and the axial end face.

8. The control arrangement according to claim 5,
wherein the diagonal surface limits the at least one cutout axially with respect to the main axis, and
wherein the undercut is formed by the axial surface.

9. The control arrangement according to claim 8,
wherein the undercut is inserted in the outer lateral surface of the guide bush, and
wherein a shearing edge is formed between the axial surface and the outer lateral surface.

10. The control arrangement according to claim 5, wherein the axial surface and the diagonal surface are connected to one another inside of the at least one cutout via a radius.

11. The control arrangement according to claim 1, wherein the at least one cutout is formed continuously in circumferential direction.

12. The control arrangement according to claim 1, wherein the at least one cutout is produced by cutting.

13. The control arrangement according to claim 1, wherein the guide bush has at a second axial end a radially outwardly directed positive connection contour via which the spring unit is axially supported with respect to the main axis.

14. A method for producing a control arrangement comprising:
preassembling a spring unit, a control piston and a control pot coaxially relative to one another at a guide bush;
plastically deforming a pot base of a control pot is in an axial direction with respect to a main axis by a deformation tool; and
displacing a base material of the pot base under an application of force into a cutout at a first axial end of the guide bush to form a positive engagement connection.

15. The method according to claim 14, wherein the spring unit and the control piston are preassembled in an intermediate step at the guide bush, and the guide bush is plastically deformed in an axial direction with respect to the main axis by a further deformation tool, wherein a base material of the guide bush is displaced radially outward to form a transport security.
